(19) United States
(12) Patent Application Publication
(10) Pub. No.: US 2006/0290948 A1
(43) Pub. Date: Dec. 28, 2006

(54) Undesirable output detection in imaging device

(75) Inventor: Andrew R. Ferlitsch, Tigard, OR (US)

Correspondence Address: ROBERT VARITZ, 4915 SE 33RD PLACE, PORTLAND, OR, 97202, US

(73) Assignee: Sharp Laboratories of America, Inc.

(21) Appl. No.: 11/168,061

(22) Filed: Jun. 27, 2005

(51) Int. Cl. G06F 3/12

(52) U.S. Cl. 358/1.1; 358/1.14

(57) ABSTRACT

A method for detecting and managing undesirable output in the operation of an imaging system which includes an imaging job format interpreter, an output engine downstream from the interpreter, and a processing region intermediate the interpreter and the engine. The method operates in the processing region, and involves independently examining imaging-job data to detect the possibility that a particular imaging job is potentially a candidate for creating undesirable output, and placing such a job candidate, as least temporarily, in a state of suspension from completion.

### BACKGROUND AND SUMMARY OF THE INVENTION

This invention involves a methodology for solving a family of imaging output problems which spring from various kinds of failures, during an imaging operation with respect to an imaging job, to identify correctly the language format of an imaging job. Such a failure can result in what will be referred to herein as an undesirable or undesired imaging output. Illustrations of such undesirable outputs includes (a) the outputting of blank pages (excess paper consumption), (b) the excessive use of toner, (c) the printing of pages containing amounts of meaningless data, (d) the presence of unprintable text, (e) the occurrence of a blank front-page side of a duplex (two-sided) document, and (f) the occurrences of other unwanted output conditions.

The background of this invention, and the unique resolution approach which is offered by the invention, are now set forth immediately below, followed by a detailed, and illustrated description of a preferred and best-mode implementation of the invention. Throughout this document where reference is made to image or imaging, it should be understood that this reference is intended to include the practices of printing, copying, faxing, scanning, document/image archiving/retrieving, and other practices such as spectrum generation and analysis used for example with x-ray and MRI work. A referred-to imaging device or imaging system may, as illustrations, be any one of a printer, a copier, a scanner, a facsimile device, an electronic white board, a multi-functional peripheral device, a document server, and still other imaging structures.

When an imaging device an (imager) receives an imaging job, it must interpret and render the job according to the imaging-job format. The imager must determine the format of the job either explicitly or implicitly (e.g., via automatic language switching). In either case, the job could be rendered incorrectly and possibly produce an undesirable output, such as when:
1. A mismatch between the interpreter and language format occurs;
2. An unsupported variant in the language format exists;
3. There is corruption in the imaging job;
4. An undetected language format switch lies within the imaging job; and
5. The job is a malicious job.

A user will generally consider an imaged outcome, or output, to be undesirable for a variety of reasons, such as, for example if a large number/quantity of consumables (e.g., paper sheets and/or toner) are consumed. Another example includes the outputting of a large number of blank pages, or the outputting of pages with small amounts of meaningless data.

These kinds of problems can happen when, as an illustration, a multi-language-supporting imaging device receives imaging data without an explicit indication of the language format. The imaging device must sample the imaging data and determine the language format. This process is commonly referred to as automatic language switching. In some prior art approaches, if an imaging-job language is not determinable, an imaging device will select a language format by default. In this case, if the default-selected format and the actual job format are mismatched, the associated interpreter/renderer will produce an unknown outcome. For example, this kind of an issue can develop with the well-known Zoran Integrated Print Subsystem (IPS) 6.0 which supports automatic language switching using a sampling technique and an optional default interpreter.

Another kind of undesirable outputting occurs when a non-PCL job is interpreted by a PCL interpreter. Because of PCL roots as a text formatting print language, a PCL interpreter does not require the entire input to be specified as explicit printing instructions in a well formed manner. Instead, it allows printing instructions (which begin with the unprintable <Esc> character) to be interspersed among plain text. Whenever the interpreter does not encounter an instruction, it process the data stream (up until the next recognized printing instruction) as a text stream, and prints it according to the current selected font. Thus, nothing appears to be improper.

However, the problem with this situation is that if a non-PCL job (e.g., a Postscript job) is interpreted by a PCL interpreter, any outcome is possible, because the interpreter is likely to interpret and attempt to render the entire print stream, regardless of what is encountered, without reporting an error.

Still another cause of undesirable outputting takes place with modern imaging jobs which contain a mix of language formats, such as having sub-objects of a different language format (e.g., Encapsulated Postscript (EPS) or Portable Document Format (PDF) objects). In this case, an imaging job is first interpreted/rendered according to the language format with which the job starts. As the job proceeds, the interpreter may not realize that the language format has changed (e.g., encounters an embedded object), and may incorrectly continue to interpret/render according to the first format. If the interpreter does not detect an error, or detects it late, an undesirable output may occur.

In another example of undesirable outputting, an imaging job may be processed by the correct imaging format interpreter, but may have proprietary commands that are not recognized by an imager's selected interpreter. Again, if an error is not detected, or is detected late, an undesirable output may occur.

As was noted earlier herein, there are other kinds of undesirable outputting situations which need also to be addressed.

Thus, there is a need for a more effective method for detecting when the rendering of an imaging job will produce an undesirable output which can produce a substantial waste of consumables. Preferably, such a method will be independent of the language format associated with an imaging job and an interpreter.

The present invention addresses these concerns with an effective method, based independently upon a review of imaging job data, to detect whether an interpretation and rendering of an imaging job is likely to produce an undesirable output before that output can happen. Further, this invention offers a method that is independent of the language format of an imaging job and of an interpreter.

The method of this invention, as will be seen, is implemented downstream from the interpreter in an imaging system, such that it is interpreter-independent, and upstream from the output renderer (output/marking engine).

According to the method of the invention, each logical and/or physical element generated (e.g., page, image, sheet surface) is analyzed in an intermediate, or device-specific, format for the possibility of an undesirable outcome. Such formats include display lists (DL), bitmaps, raster images, and others. More specifically, each job element, such as a page, is analyzed using a low parse method to look for patterns that are suggestive of possible undesirable outcomes.

Examples, from the larger list presented above, include:

1. Blank pages;
2. Excessive use of toner; and
3. Low content on a page.

Analyzed information is stored in a repository (or queue). Prior to final outputting, or as a job is being outputted, another process examines the information in the repository to determine the likelihood that the job will produce an undesirable outcome. The methods used to examine such information are driven by a set of configurable rules which can be set by an administrator, an operator, or automatically by the imaging system per se.

Examples of rules include:
1. Excessive number of blank pages relative to the total number of pages;
2. Excessive number of consecutive blank pages;
3. High use of toner, as averaged across all job pages;
4. Low content relative to the total number of pages;
5. Excessive clipping of content; and
6. Content being obscured by binding options.

Once a job has been determined to be a possible candidate for an undesirable outcome, the job is suspended. Final handling resolution for a suspended job is then determined by an interaction between an operator and the imaging system, such as interaction via a front panel or a remote dialog. A user/operator is provided with information regarding the reason that a job is suspected and suspended, and is asked to look at any output generated so far. The user/operator then has the choice to resume or cancel the job. If the job is resumed, the undesirable outcome analysis is disabled for the remainder of the job.

These and other features and advantages which are offered by the present invention will become more fully evident as the detailed description of the invention which now follows is read in conjunction with the accompanying drawings.

### DESCRIPTION OF THE DRAWINGS

FIG. 1 is a high-level, block/schematic diagram illustrating the invention in it preferred and best-mode overall form.

FIG. 2 is a somewhat more detailed block/schematic diagram illustrating one specific form of the invention wherein, before actual practice of the invention to detect and handle output difficulties for an imaging job headed toward outputting, the input job data for the job is first converted to an intermediate, or device-specific, data format, such as to a DL for temporary storage in a queue, after which this “converted-to” data is examined to find outputting issues.

FIG. 3 is similar to FIG. 2, except that it shows another specific form of the invention wherein input job data is directly converted to an output-engine-ready data format, and then temporarily stored in a queue before examination for outputting problems.

FIG. 4 is a block/schematic diagram of imaging-job pre-output examining in the context of display-list processing.

FIG. 5 is similar to FIG. 4, except that it illustrates practice of the invention employing direct conversion of input job data to output-engine-ready-data.

FIG. 6 illustrates, practice of the present invention to analyze whether an input imaging job has an “unwanted population” of blank pages.

FIG. 7 shows a post-analysis specific detection of an “over-population” of blank pages.

FIG. 8 pictures schematically what is referred to herein in the practice of the invention as object density detection.

FIG. 9 pictures schematically a practice herein called object density analysis.

FIG. 10 shows, in block/schematic form, a practice referred to herein as compression density detection.

FIG. 11 illustrates a practice of the invention called compression density analysis.

FIG. 12 illustrates what is called herein imaging-job suspension.

FIG. 13 provides an illustration of rule configuration with respect to rules which are employed in accordance with practice of the invention to detect potential undesirable output problems.

### DETAILED DESCRIPTION OF THE INVENTION

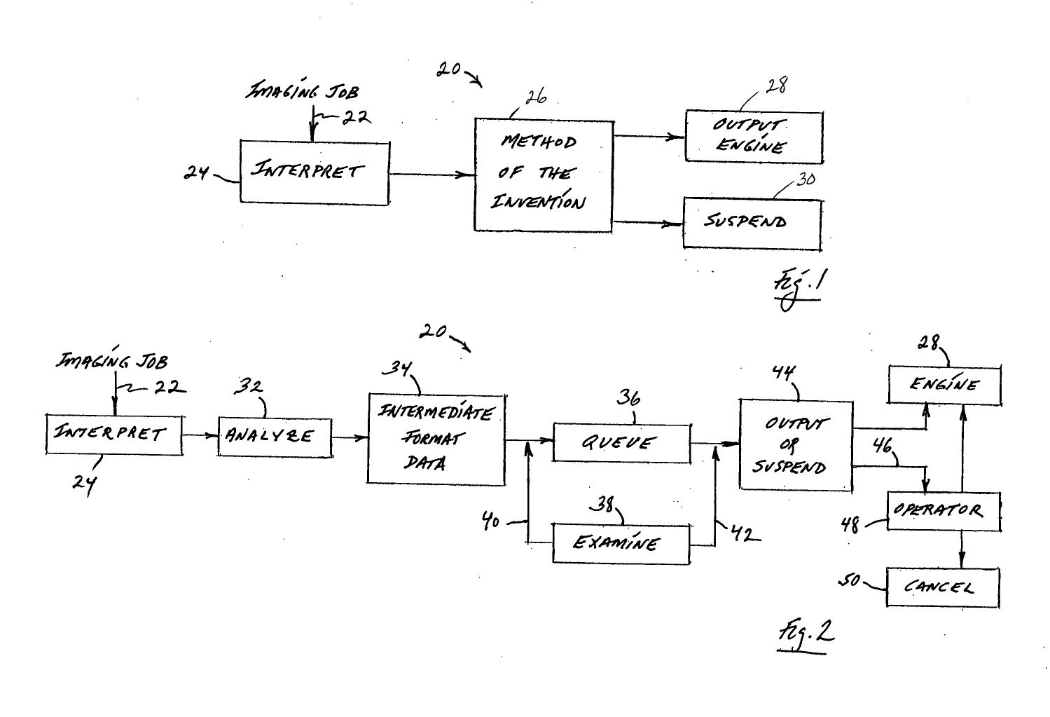

Turning now to the drawings, and beginning with FIGS. 1-3, inclusive, in the practice of the present invention, an imaging device, or system, 20 (e.g., printer, fax) receives an imaging job 22 for processing. Upon job receipt, the imaging device determines the format of the imaging job and assigns processing of that job to an imaging interpreter 24 which preferably is specific to the determined format. The determination of the format may take place in any manner, such as those set forth in the non-exclusive list immediately below:
1. Explicit Language Switch—The imaging job may contain a command which indicates the language format. For example, in a print job, the language may be specified by the HP PJL command: @PJL ENTER LANGUAGE=<format>.
2. Implicit Language Switch—The format of the imaging job is determined here by examining some subset of content of the job to identify a unique format-specific signature. For example, the first few bytes of the file may be examined and compared against signatures of standard file formats (e.g., % !PS for Adobe Postscript and % PDF for Adobe Portable Document Format (PDF)). The format may also be determined by other information, such as a file type (e.g., .tif suffix for TIFF).
3. Default Language—The device may only support one format and may assume that all input is of the supported format, or the language format may not be recognized, and a predetermined default language format may be selected.
4. Operator—The operator may enter the format, such as from the front panel of the imaging output device, or from a remote interface, such as an imaging driver or a device-embedded web page.

Focusing specific attention for a moment now specifically on FIG. 1 in the drawings, in addition to a block 24 which is labeled INTERPRET, and which functions as the above mentioned imaging interpreter, three other blocks 26, 28, 30 appear in this figure. Block 26 generally represents the methodology of the present invention, which methodology is this seen to “lie”, effectively, intermediate blocks 24 on the one hand, and blocks 28, 30 on the other. Block 28 represents an output, or marking, engine in system 20, and block 30 represents what can be thought of as a state of suspension which may result from operation of the methodology of the invention, as will shortly be more fully described.

Thus what can be seen clearly in FIG. 1 is that the method steps involved in practicing the present invention sit, operationally so-to-speak, downstream from where initial imaging job interpretation takes place, and upstream from where an associated output engine, or device, is located. Generally speaking, the region seen in FIG. 1 which lies between block 24 on the left side of the figure, and blocks 28, 30 on the right side of this figure, is referred to herein as a processing region.

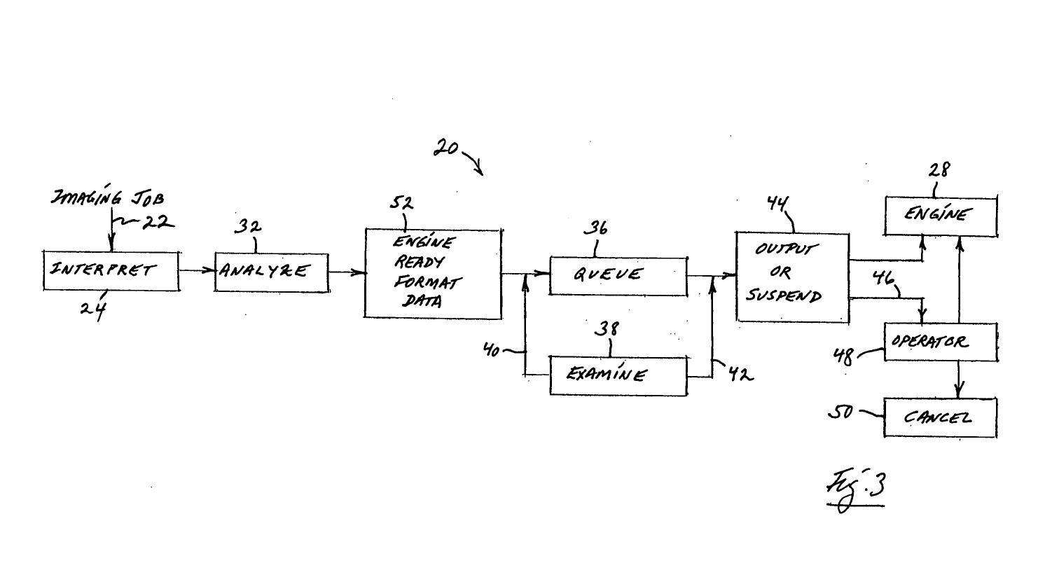

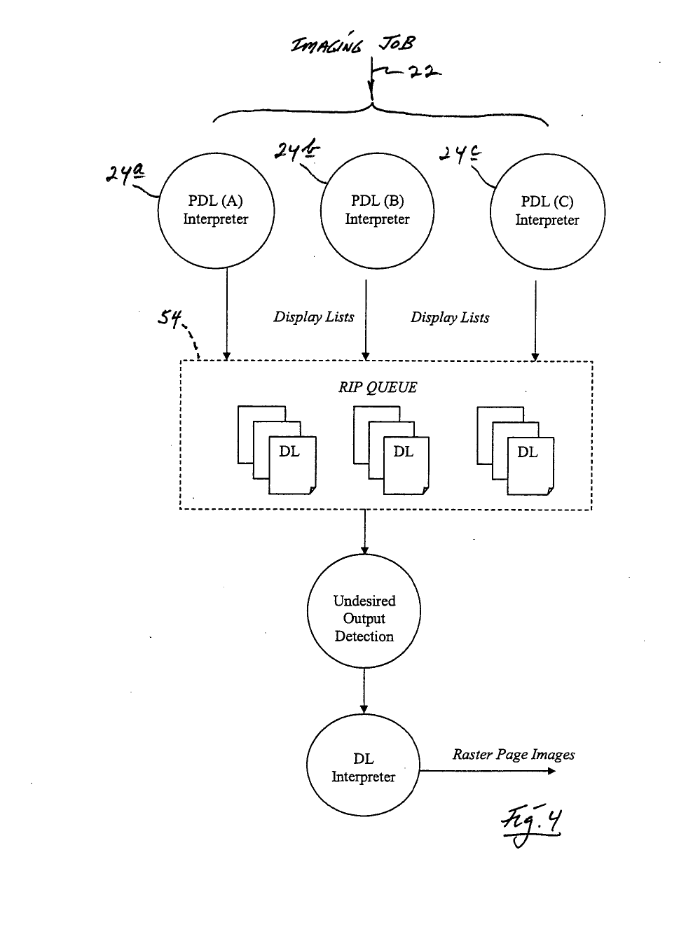

FIGS. 2 and 3, which furnish somewhat more detailed illustrations of the invention, are presented herein to show two, slightly different, basic “avenues” for performance of the steps of the invention.

According to what is shown in FIG. 2, once imaging-job interpretation has taken place, a basic analysis, represented by a block 32, and which will be more fully described later herein, takes place, and the analyzed job data is converted in block 34 into what is referred to herein as an intermediate data format, such as display list (DL). This reformatted data is then passed along to a queue, or repository, 36 on its way for subsequent processing, and ultimate intended delivery to output engine 28.

It is in the region generally associated with queue 36 that the reprocessed data, according to a set of rules still to be described, is examined in block 38, to detect a condition which may produce an undesirable output as explained earlier. One will notice in FIG. 2 that block 38 is shown effectively as being operatively connected by arrow-headed lines 40, 42 to the left and right sides, respectively, of block 36. This illustrated twin connection is actually presented to describe alternate ways in which data examination can take place. In other words, only one of these two indicated operative connections will typically be employed, and the other one won't exist. Arrow 40 indicates a style of data examination which takes place as reformatted data coming from block 34 flows, by streaming, toward queue 36. Arrow 42 illustrates another data-examination approach with respect to which data passing from queue 36 toward the right side of FIG. 2 is either fully examined (i.e. full job) before any data is passed along, or is analyzed in what can be thought of as a parallel manner with respect to output data flowing from queue 36.

Data from queue 36, examined by block 38, flows to block 44 wherein, depending upon the outcome of data examination, a job is either output to engine 28, or is suspended if the likelihood of undesirable output has been detected.

Suspended data is appropriately “furnished”, via an arrow-headed line shown at 46, to the system operator shown at 48. In accordance with practice of the present invention, such furnished “suspend” information going to the operator allows the operator to implement either one of two different courses of action, one of which results in job cancellation, as represented by block 50, and other of which results in a command to deliver the suspended data to engine 28 after an operator has determined that, for example, undesirable output will probably not occur.

In FIG. 3 which is very similar to FIG. 2, blocks which are essentially the same as those shown in FIG. 2 bear the same respective reference numerals. Distinguishing FIG. 3 from FIG. 2 is that format-interpreted and basically analyzed imaging job data is converted in a block 52 immediately into an engine ready data format, and is then passed to queue 36. Operation of the methodology of this invention in accordance with what is shown in FIG. 3 is otherwise substantially the same as the operation which has just been described above with respect to FIG. 2.

A more detailed explanation of the invention and its approaches are now described with reference to FIGS. 4-13, inclusive, in the drawings. Those generally skilled in the art will understand immediately, by looking at these drawing figures, just what is being illustrated in relation to the operation of the invention. In other words, these several drawing figures are self-explanatory to such a skilled-in-the-art person. Accordingly, the following text relating to these figures is provided only at a very high level as a recognition that the drawings essentially speak for themselves. As one will see, the descriptive language which is used herein to focus attention on key matters illustrated in drawing FIGS. 4-13, inclusive, is somewhat abbreviated, or shorthand-like, in nature, and is presented in this fashion not only for the reason that these several drawing figures self communicate features of the invention, but also because the shorthand-like descriptive jargon presents the relative discussion in essentially the fashion that those skilled in the art speak about what if shown in these drawing figures.

Beginning with what is illustrated in FIG. 4, an imaging job 22 is processed by a selected language format interpreter (three different interpreters are shown at 24a, 24b, 24c) into an intermediate format (i.e., pre-output ready format), such as a display list. In this case, the intermediate data is generally produced in an ordered sequence (e.g., page output order) and placed into processing queue 54 for subsequent processing into output engine ready data (e.g. raster image processing (RIP) in a printer). The intermediate data is examined by the undesirable output detection process either as the intermediate data is placed on the processing queue (i.e., streaming), or after the entire imaging job has been converted to intermediate data.

In the later case, processing of the intermediate data into output engine ready data may be delayed until completion of the undesirable output detection process, or may occur in parallel.

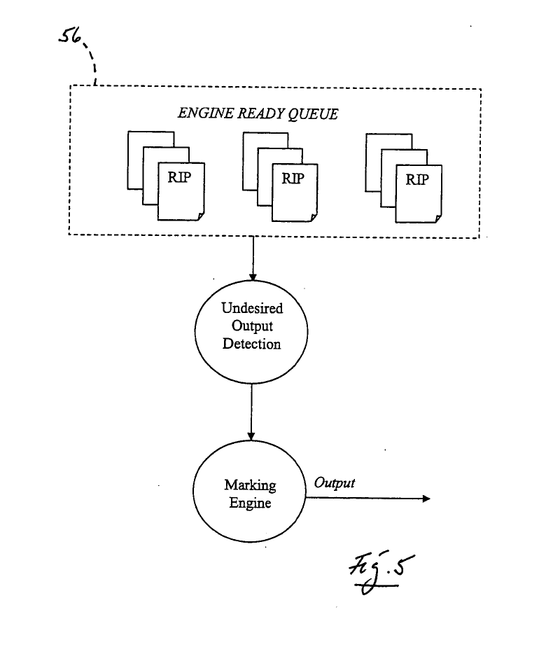

In FIG. 5, an imaging job is processed by the selected language format interpreter into an output engine ready format (e.g., device specific raster images). In this case, the output engine ready data is generally produced in an ordered sequence (e.g., sheet output order, fax page transmission order, scan image transmission order) and placed into the output engine ready queue 56 for subsequent outputting by the output engine (e.g., print engine). The output engine ready data is examined by the undesirable output detection process either as the data is placed on the output engine ready queue (i.e., streaming), or after the entire imaging job has been converted to output engine ready data.

In the latter case, outputting of the output engine ready data may be delayed until completion of the undesirable output detection process, or may occur in parallel.

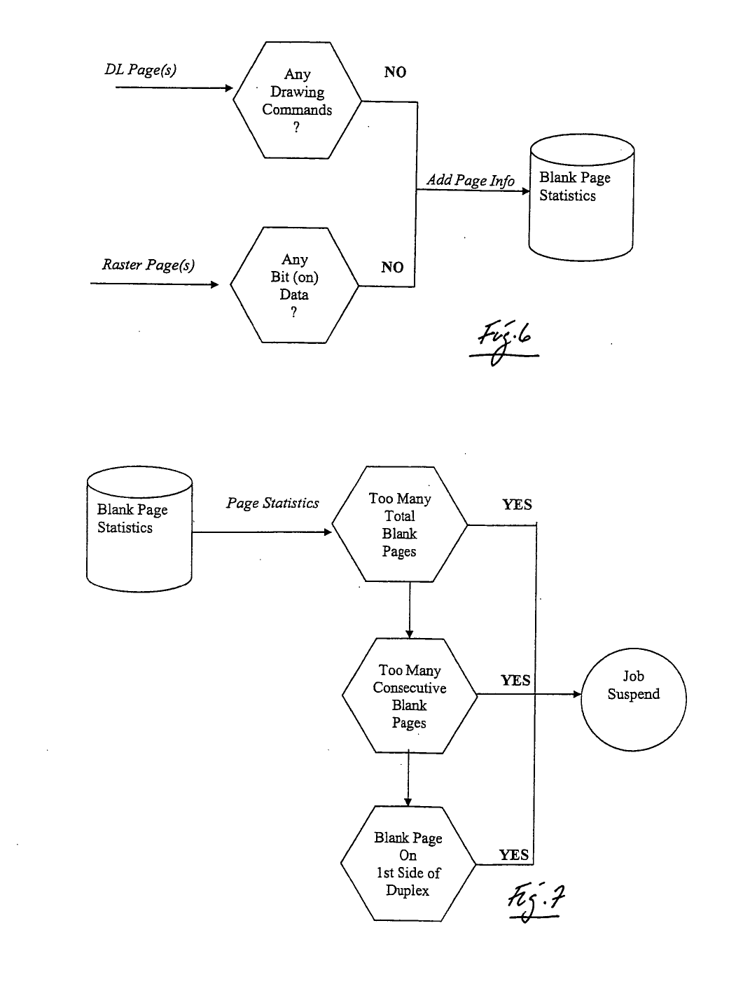

Turning attention to FIG. 6, one approach for determining an undesirable output involves detecting and analyzing blank page generation. In some cases, blank pages can be valid, and the method must not mistake valid blank pages as undesirable. Thus, the existence of blank pages does not by itself indicate an undesirable output.

Examples of valid blank pages might include:
1. Back side (odd page) of a duplex sheet;
2. Ending blank pages of a booklet;
3. Separations between sub-jobs (e.g., sequence of invoices printed as a continuous print job).

Two operational phases, detection and analysis, are illustrated in FIG. 6. During the detection phase, each logical page (e.g., document page) or physical page (e.g., surface of a sheet) is analyzed to determine if the page will be rendered blank by the output engine. For example, if the analysis is on a display list (DL) page, then the DL commands can be parsed (w/o interpretation), and each command categorized as either a content outputting command (i.e., renders content on the output), or a non-content outputting command (e.g., page setup, fill pattern, color space, etc.). If there are no content outputting commands, the page is determined to be blank.

Analysis is performed on an output engine ready page (e.g., raster page) in the form of a bitmap image. In this approach, a bitmap image is compared to a mask to determine if any bit is set that will generate content (e.g., ink on paper) when outputted. If there are no bits that will cause content to be outputted, the page is determined to be blank.

The gathered information on each page is then added to a blank page statistics repository. The information contains at least the logical or physical position in the output.

The above processes may occur on a page either before the page is processed by the image output device for a next stage in the imaging process, or in parallel.

FIG. 7 shows how blank page statistics may be analyzed. As illustrated here, blank page statistics are analyzed either:
1. In parallel with the detection process; or
2. At the end of the detection process; or
3. At some interval points (e.g., every 10 pages) in the detection process.

The analysis process uses a set of configurable rules to determine if the output would be undesirable based on blank pages.

Examples of rules include:
1. The total number of blank pages exceeds some threshold, where the threshold may be set:
   a. A pre-configured fixed number of pages;
   b. Relative to the size of the job, the interval page size, or current number of pages examined;
2. Too many consecutive blank pages, where the number of consecutive blank pages may be set:
   a. A pre-configured number of pages;
   b. Relative to the size of the job, the interval page size, or current number of pages examined;
3. Illogical location in sheet assembly order, such as:
   a. Front side (even page) of a duplex print;
   b. Leading pages in an N-up print;
   c. Leading pages in a booklet print.

This process may be further configured based on the number of detected blank page occurrences.

The process may determine that output will be undesirable if:
1. If any of the above conditions exist; or
2. Each condition has a weighted value, and the accumulative weighted value exceeds a predetermined threshold. Additionally, if weighted, may be combined with other methods.

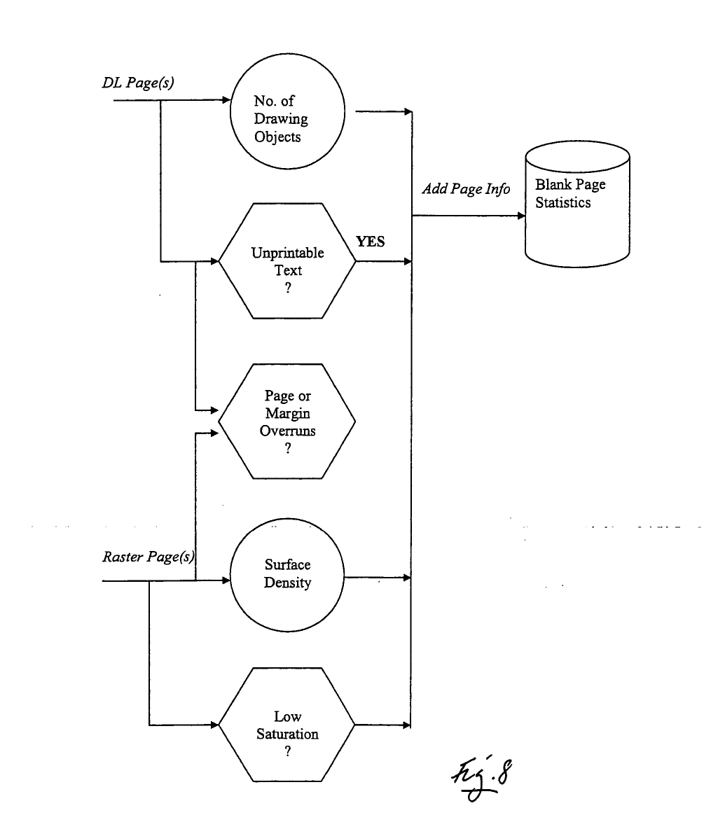

Another approach illustrated in FIG. 8, involves detecting and analyzing low object density per output element (e.g. page). In some cases, low object density pages can be valid, and the method must not mistake valid low object density pages as being undesirable. Thus, the existence of low object density pages does not by itself indicate an undesirable output. Examples of valid low object density pages might include:
1. Title or Section Pages;
2. Pages within a document within progress (i.e., document is not completed yet);
3. A page showing a singular example (e.g., screen shot);
4. Pages used as separators between sub-jobs.

Processing here is decomposed into two phases: a detection phase and an analysis phase.

During the detection phase, each logical page (e.g., document page) or physical page (e.g., surface of a sheet) is analyzed to determine if the page will be rendered with low density objects by the output engine. For example, if the analysis is on a display list (DL) page, then the DL commands can be parsed (w/o interpretation) where:
1. The total number of content outputting commands are counted;
2. The number of content outputting commands that cannot be outputted (e.g., unprintable text);
3. The number of content outputting commands that will be clipped due to page and binding margins.

In another example, the analysis may be performed on an output engine ready page (e.g., raster page) in the form of a bitmap image. In this approach, a bitmap is analyzed with a bitmap mask, or masks, where:
1. The surface density is determined (i.e., proportion of surface that will have content outputted);
2. The percentage of surface with content whose saturation (e.g., visibility) is below a threshold, where the threshold is either predetermined or configurable, or, the average saturation for the proportion of the surface that has content;
3. The amount of the bitmap containing content that will be clipped due to page and binding margins.

The gathered information on each page is then added to an object density statistics repository. The relevant information contains the logical or physical position in the output.

The above processes may occur on a page either before the page is processed by the image output device for the next stage in the imaging process, or in parallel.

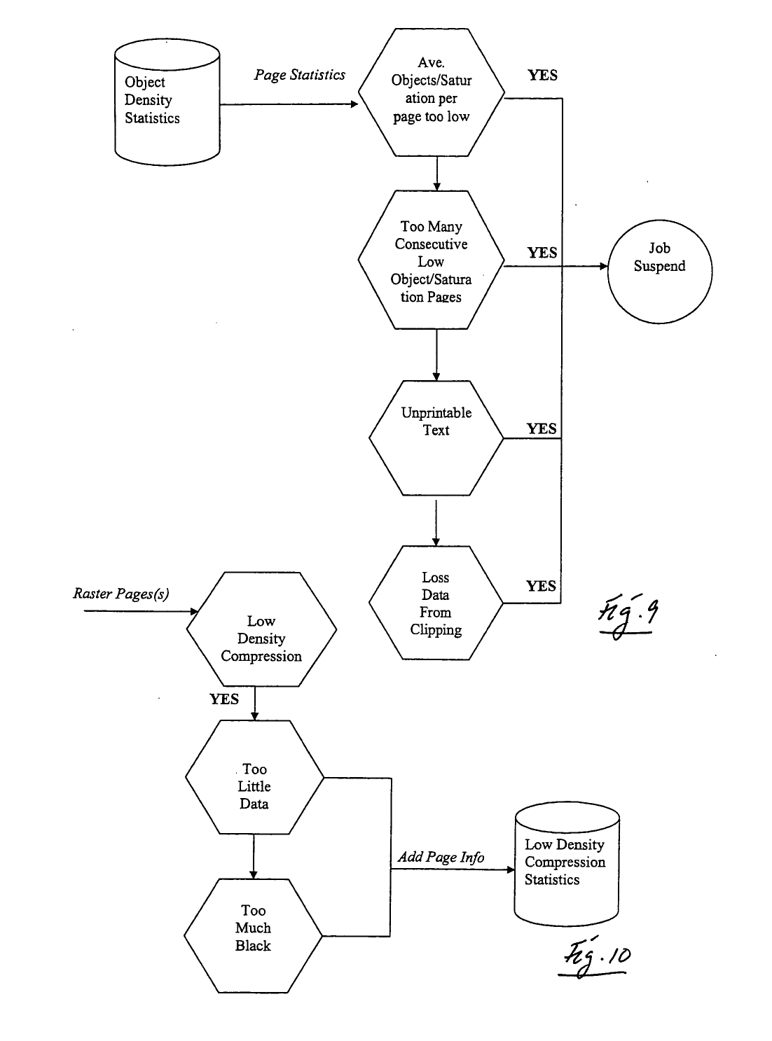

FIG. 9 illustrates object density analysis. Here the object density statistics are analyzed either:
1. In parallel with the detection process;
2. At the end of the detection process;
3. At some interval points (e.g., every 10 pages) in the detection process.

The analysis process uses a set of configurable rules to determine if the output would be undesirable based on low object density pages. Examples of relevant rules include:
1. The average amount of surface coverage is below some threshold, where the threshold may be:
   a. A pre-configured percentage;
   b. Relative to the size of the job, the interval page size, or current number of pages examined;
2. The total amount of surface coverage below a saturation threshold, whereby the saturation threshold may be pre-determined and the total threshold may be:
   a. A pre-configured percentage;
   b. Relative to the size of the job, the interval page size, or current number of pages examined;
3. Too many consecutive low saturation pages, where the number of consecutive low saturation pages may be set:
   a. A pre-configured number of pages;
   b. Relative to the size of the job, the interval page size, or current number of pages examined;
4. The total amount of content that is unprintable is above some threshold, whereby the threshold may be:
   a. A pre-configured percentage;
   b. Relative to the size of the job, the interval page size, or current number of pages examined;
5. Too many consecutive pages with unprintable content, where the number of unprintable content pages may be:
   a. A pre-configured number of pages;
   b. Relative to the size of the job, the interval page size, or current number of pages examined;
6. The total amount of content that is clipped is above some threshold, whereby the threshold may be:
   a. A pre-configured percentage.
   b. Relative to the size of the job, the interval page size, or current number of pages examined;
7. Too many consecutive pages with clipped content, where the number of clipped content pages may be:
   a. A pre-configured number of pages;
   b. Relative to the size of the job, the interval page size, or current number of pages examined.

The detection process may determine that the output is undesirable if:
1. If any of the above conditions exist; or
2. Each condition has a weighted value, and the accumulative weighted value exceeds a threshold. Additionally, if weighted, may be combined with other methods.

FIG. 10 illustrates another practice approach offered by the present invention, and specifically, an approach involving compression density detection and analysis. Specifically what one looks for is low compression density per output element (e.g. page). In some cases, low post-compression density pages can be valid, and the method must not mistake valid low post-compression density pages as undesirable. Thus, the existence of low post-compression density pages does not by itself indicate an undesirable output. Examples of valid low post-compression density pages might include:
1. Large use of solid fill business graphics;
2. Sparse bi-tonal text.

In this approach, processing is decomposed into two phases—a detection phase and an analysis phase.

During the detection phase, each logical page (e.g., document page) or physical page (e.g., surface of a sheet) is analyzed to determine if the page has a low density after compression. Typically, this method of analysis is performed on bitmap data, which may either be output engine ready data, source reference raster data, or encoded bitmap data (i.e., image data, such as TIFF). The compressed bitmap data is then analyzed, where:
1. The size of the compression image is determined;
2. The number of compressed segments (e.g., run-length encodings) is below a threshold, where the threshold is either pre-determined or configurable;
3. The number of compressed segments of the same value (e.g., same toner inkings) is above a threshold, where the threshold is either pre-determined or configurable.

The gathered information on each page is then added to a low density post-compression statistics repository. The information here contains the logical or physical position in the output.

The above processes may occur on the page either before the page is processed by the image device for the next stage in the imaging process, or in parallel.

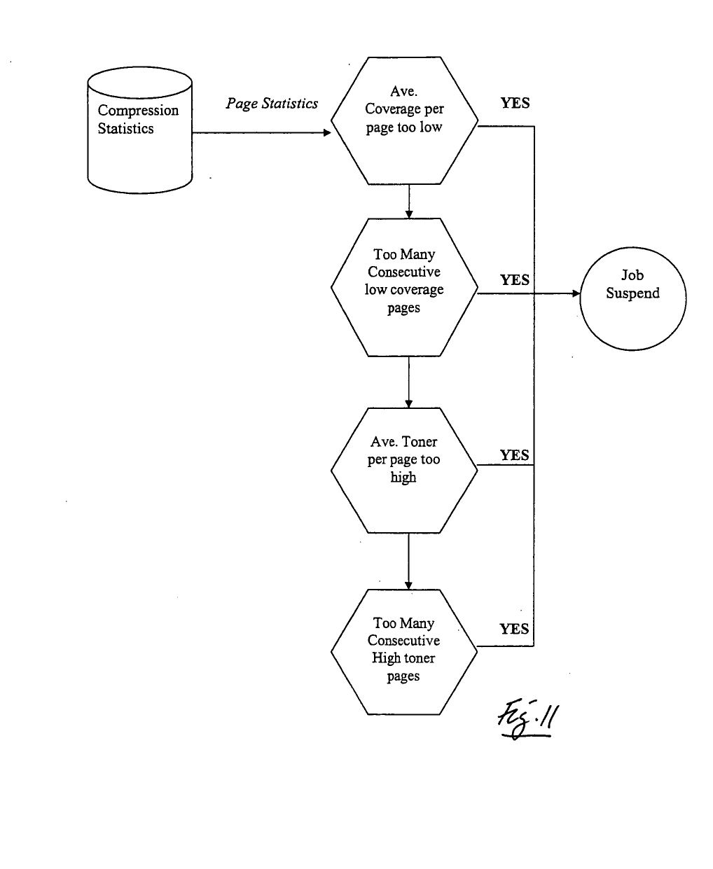

With reference now to FIG. 11, here is illustrated another density analysis approach. In this approach, object density statistics are analyzed either:
4. In parallel with the detection process;
5. At the end of the detection process;
6. At some interval points (e.g., every 10 pages) in the detection process.

The analysis process uses a set of configurable rules to determine if the output would be undesirable based on low post-compression density pages. Examples of rules include:
1. Average coverage (e.g., toner) per page is below a threshold, where the threshold may be:
   a. A pre-configured percentage;
   b. Relative to the size of the job, the interval page size, or current number of pages.
2. Too many consecutive pages with low coverage, where the number of low coverage pages may be:
   a. A pre-configured number of pages;
   b. Relative to the size of the job, the interval page size, or current number of pages examined.
3. Average coverage (e.g., toner) per page is above a threshold, where the threshold may be:
   a. A pre-configured percentage;
   b. Relative to the size of the job, the interval page size, or current number of pages.
4. Too many consecutive pages with high coverage, where the number of high coverage pages may be:
   a. A pre-configured number of pages;
   b. Relative to the size of the job, the interval page size, or current number of pages examined.

From the application of this approach, image outputting may be determined to be undesirable if:
1. If any of the above conditions exist; or
2. Each condition has a weighted value, and the accumulative weighted value exceeds a threshold. Additionally, if weight, may be combined with other methods.

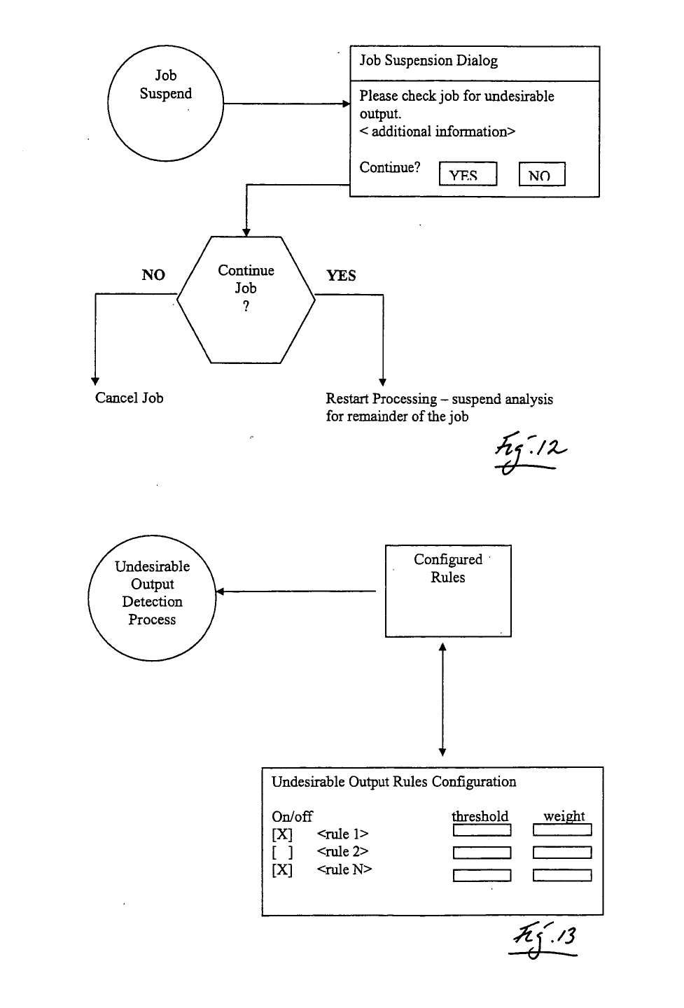

Tuning attention now to job suspension and possible resumption, and looking at FIG. 12, when a job is determined to be a candidate for undesirable output, the job is suspended. During suspension, the imaging device may optionally process other jobs. When the job is suspended, a dialog is displayed to the user (or administrator) containing the information gathered that caused the suspension. The dialog may be displayed to the user by:
1. An alert message on the control panel (local or remote) of the device;
2. A suspension state indicated on a job selection menu on the control panel (local or remote) of the device;
3. An alert message to the originating host computing device;
4. An alert message to an address (e.g., IP address) specified in the job;
5. An alert message to a pre-configured address in the device.
   The dialog will additionally ask the user to choose either to cancel or resume the job. The user may issue a cancel/resume decision either by:
1. A response in the dialog; or
2. A response on the control panel (local or remote) of the device.

If the job is canceled, the remainder of the job is purged and the associated imaging system continues with processing of the next job, if any. If a job once suspended is resumed, the undesirable output process is disabled for the remainder of the job, and the job continues processing from where it was suspended.

In the practice of this invention it is possible to enable user or system configuration and reconfiguration of the rules of which are used to handle the undesirable output situation. FIG. 13 is illustrative. Generally, the rules are pre-configured into the system, but according to the invention, an operator or administrator can configure the following:
1. Which rules are enabled/disabled;
2. Set thresholds for rules;
3. Set weighted values per rule.

Throughout this invention description, the concept of imaging includes printing, copying, faxing, scanning, document/image archiving/retrieving, and other matters such as spectrum generation and analysis, for example, is involved with as X-ray and MRI work. An imaging device may be a printer, a copier, a scanner, a facsimile device, an electronic whiteboard, a multi-functional peripheral, and a document server.

One can thus see that the present invention is relatively quite simple in its construction and logic and implementation. Basically it involves introducing certain detection analysis and examination steps aimed at imaging data in a region in the imaging processing methodology and system which sits intermediate a data input interpreter and a data output imaging device such as a marking engine. Imaging data, just before examination to detect candidacy for producing undesirable output, may either be converted into an intermediate data format, such as a display list, or may be directly converted into output engine ready data, and in each case stored in a queue or repository before being passed along to an imaging output device.

Various features which will be reflected in the repository held data which can be read to give a clue about the likelihood of an undesirable output in any one or more of the categories of undesirable outputs expressed above, occurring if that job data is permitted, so-to-speak, to go unchallenged to completion in the form of outputting. Detection of something in this examined imaging data which point toward undesirable outputting causes the associated job to be suspended in a manner which allows a system operator to abide by the suggested suspension with the entire related job then completely cancelled, or overridden by an operator decision to allow job completion without abiding by the imagining system “decision” to suspend the job.

Those generally skilled in the art will most certainly readily be able to practice the invention simply by a studying, and an understanding of, what is shown expressed in high level figures two and three in the drawings. The other drawing figures illustrate and detail certain sub-features within what is shown in FIGS. 2 and 3, and are believed to be helpful in calling attention to certain specific detection analysis and examination procedural steps which may be considered in the implementation of the invention.

The novel method of the invention can be expressed as one which is aimed at the detecting and managing of undesirable output in the operation of an imaging system where that system includes an imaging job format interpreter, an output engine which is located downstream in the system from the interpreter, and an imaging data processing region which is disposed intermediate the interpreter and the engine, with this method including the steps of (a) within the processing region examining imaging-job data to detect the possibility that a particular imaging job is potentially a candidate for creating undesirable output, and (b) placing such a job candidate, at least temporarily, in a state of suspension from completion.

Yet another way of expressing the methodology of this invention is to describe it as being a method for the detection of prospective undesirable output in the operation of an imaging engine, including the steps of (a) establishing an implementable, post-interpreter practice for detecting, relative to the format of an imaging job which is presented to the system, selected categories of potential, undesirable image outputs, (b) effectively placing that practice at a location which is operatively intermediate an imaging job data format interpreter and an output imaging-job engine, which are upstream/downstream, respectively, in such a system, and (c) implementing this placed practice then with respect to imaging-job data whose format is interpreted by the interpreter.

Accordingly, while a preferred embodiment of, and manner of practicing, the present invention have been described and illustrated herein, with certain variations and modifications suggested, it is appreciated that other variations and modifications may be made without departing from the spirit of the invention.

I claim:

1. A method for detecting and managing undesirable output in the operation of an imaging system which includes an imaging job format interpreter, an output engine downstream from the interpreter, and a processing region intermediate the interpreter and the engine, said method comprising
in the processing region, examining imaging-job data to detect, independently, from that data the possibility that a particular imaging job is potentially a candidate for creating undesirable output, and
placing such a job candidate, as least temporarily, in a state of suspension from completion.

2. The method of claim 1, wherein said examining is performed by applying selected rules to imaging-job data.

3. The method of claim 2 which further comprises enabling selective configuration of the rules.

4. The method of claim 2, wherein said applying utilizes candidate-indicating rules drawn from a non-exclusive list including: (a) an excessive number of blank pages relative to the total number of job pages; (b) an excessive number of consecutive blank pages; (c) a high-use-of-toner average across all pages in a job; (d) low content relative to the total number of job pages; (e) excessive clipping of content; f) unprintable text; (g) a blank front-page side of a duplex (two-sided) document; and (h) the presence of content obscured by binding options.

5. The method of claim 1, wherein the interpreter processes/reformats imaging-job data into an intermediate data format, which reformatted data is thereafter placed by streaming into a queue for subsequent processing into output-engine-ready data, and said examining is performed as such interpreter-processed job data is streamed into the processing queue.

6. The method of claim 1, wherein the interpreter processes/reformats imaging-job data into an intermediate data format, which reformatted data is thereafter placed into a queue for subsequent processing into output engine-ready data, and said examining is performed in the portion of the processing region which is intermediate the queue and the output engine.

7. The method of claim 6, wherein said examining is performed fully before any output-engine-data is supplied to the output engine.

8. The method of claim 6, wherein said examining is performed in parallel with the supplying of output-engine-ready data to the output engine.

9. The method of claim 1, wherein the interpreter processes imaging-job data into a format which makes it output-engine-ready data, which output-engine-ready data is thereafter placed by streaming into an output-engine-ready queue, and said examining is performed as such output-engine-ready data is streamed into the output-engine-ready queue.

10. The method of claim 1, wherein the interpreter processes imaging-job data into a format which makes it output-engine-ready data, which output-engine-ready data is thereafter placed into an output-engine-ready queue, and said examining is performed in the portion of the processing region which is intermediate the queue and the output engine.

11. The method of claim 10, wherein said examining is performed fully before any output-engine data is supplied to the output engine.

12. The method of claim 10, wherein said examining is performed in parallel with the supplying of output-engine-ready data to the output engine.

13. The method of claim 1, wherein said placing in a state of suspension is linked with offering the imaging-system operator with a choice of one of (a) canceling a job, and (b) resuming a job.

14. A method for the detection of prospective undesirable output in the operation of an imaging system comprising
establishing an implementable, post-interpreter practice for detecting, relative to the format of an imaging job presented to the system, selected categories of potential, undesirable image outputs based independently on a review of job data,
effectively placing that practice operatively intermediate an imaging-job data format interpreter and an output imaging-job engine, which are upstream/downstream, respectively, and relative to one another in such a system, and
implementing this thus placed practice with respect to imaging-job data whose format is interpreted by the interpreter.

15. A method implementable in a computer-based imaging system for preventing undesirable imaging-job output comprising
assessing imaging-job data independently to detect evidence that undesirable output may result from outputting the job, and
with regard to the positive detecting of such evidence relative to a particular job, suspending outputting of that job.

16. The method of claim 15, wherein said suspending is carried out in a user-defeatable/overideable manner.

17. The method of claim 15, wherein said assessing involves examining imaging-job data which has been formatted into one of (a) an intermediate data format, and (b) an output-engine-ready data format.

18. The method of claim 17, wherein said examining is performed in a way which is based upon selectively configurable rules for examination.
